(19) United States
(12) Patent Application Publication
(10) Pub. No.: US 2025/0276895 A1
(43) Pub. Date: Sep. 4, 2025

(54) GAS GENERATION SYSTEM

(71) Applicant: TOYOTA JIDOSHA KABUSHIKI KAISHA, Toyota-shi (JP)

(72) Inventors: Ryota TOMIZAWA, Susono-shi (JP); Koji HAYASHI, Nagakute-shi (JP); Tomoya NAGANO, Numazu-shi (JP)

(73) Assignee: TOYOTA JIDOSHA KABUSHIKI KAISHA, Toyota-shi (JP)

(21) Appl. No.: 19/023,854

(22) Filed: Jan. 16, 2025

(30) Foreign Application Priority Data
Feb. 29, 2024 (JP) 2024-029520

(51) Int. Cl. C01B 3/04; B01J 35/39; C01B 13/02

(52) U.S. Cl. CPC C01B 3/042; B01J 35/39; C01B 13/0207; C01B 2203/0277

(57) ABSTRACT

The gas generation system decomposes water in contact with the photocatalyst by sunlight to generate a mixed gas composed of oxygen gas and hydrogen gas. The gas generation system includes a housing having a light-transmission wall in which an accommodation space for accommodating water and a photocatalyst is formed. The light-transmission wall transmits the sunlight S that has directly or indirectly reached at least a part of the wall portion forming the accommodation space. The gas generation system includes an irradiation device that causes an artificial light L having a peak wavelength that is absorbed by the photocatalyst to emit light by supply of electric power, and irradiates the light-transmission wall with the emitted artificial light L, and a switch that selectively switches supply or stop of supply of electric power to the irradiation device.

### CROSS-REFERENCE TO RELATED APPLICATION

This application claims priority to Japanese Patent Application No. 2024-029520 filed on Feb. 29, 2024, incorporated herein by reference in its entirety.

### BACKGROUND

### 1. Technical Field

The present disclosure relates to a gas generation system.

### 2. Description of Related Art

Japanese Patent No. 3787686 (JP 3787686 B) discloses, as this type of technology, for example, a device that decomposes water to generate hydrogen gas and oxygen gas, by a reaction of a photocatalyst. The device has a light-transmission wall that transmits sunlight from the outside. According to the device, by having the sunlight transmitted through the light-transmission wall, particles of the photocatalyst decomposed in the water contained inside are activated, and a reaction occurs in which the water is decomposed into oxygen gas and hydrogen gas.

### SUMMARY

However, in the technology described in JP 3787686 B, sunlight of a sufficient energy amount may not be able to be irradiated onto the photocatalyst, such as at night or in bad weather. In this case, the efficiency of a decomposition reaction of the water is insufficient, and as a result, it is difficult to efficiently generate hydrogen gas.

The present disclosure has been made in view of the problem. The present disclosure has an objective to provide a gas generation system that can efficiently activate a photocatalyst and can continuously cause a decomposition reaction of water, even when sunlight of a sufficient energy amount is not able to be irradiated onto the photocatalyst, such as at night or in bad weather.

In view of the problem, a gas generation system relating to the present disclosure is a system that decomposes water in contact with a photocatalyst by sunlight and generates a mixed gas made of oxygen gas and hydrogen gas.

The gas generation system includes a housing in which an accommodation space that accommodates the water and the photocatalyst is formed, the housing having a light-transmission wall that transmits the sunlight directly or indirectly reaching a wall portion of at least one portion that forms the accommodation space, an irradiation device that emits artificial light having a peak wavelength to be absorbed by the photocatalyst and irradiates the artificial light that is emitted to the light-transmission wall by a supply of power, and a switch that selectively switches a supply or a supply stop of power to the irradiation device.

According to the present disclosure, a decomposition reaction of water can be continuously caused and hydrogen gas can be efficiently generated, by selectively switching a switch, even when sunlight of a sufficient energy amount is not able to be irradiated onto a photocatalyst, such as at night or in bad weather.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall schematic view of a gas generation system according to the present embodiment;

FIG. 2A is a cross-sectional view of a housing and an irradiation device shown in FIG. 1;

FIG. 2B is a cross-sectional view of a housing and an irradiation device shown in FIG. 1;

FIG. 3 is a schematic diagram for explaining the principle of the laser apparatus shown in FIG. 1;

FIG. 4A is a graphical representation of the relationship between peak wavelength and quantum-efficiency for a photocatalyst;

FIG. 4B is a graph showing the relation between the wave length and quantum-efficiency of artificial light for materials of light-emission elements; and

FIG. 5 is a schematic diagram illustrating another example of the configuration of the circulation system in the gas generation system according to the present embodiment.

### DETAILED DESCRIPTION OF EMBODIMENTS

### Embodiments

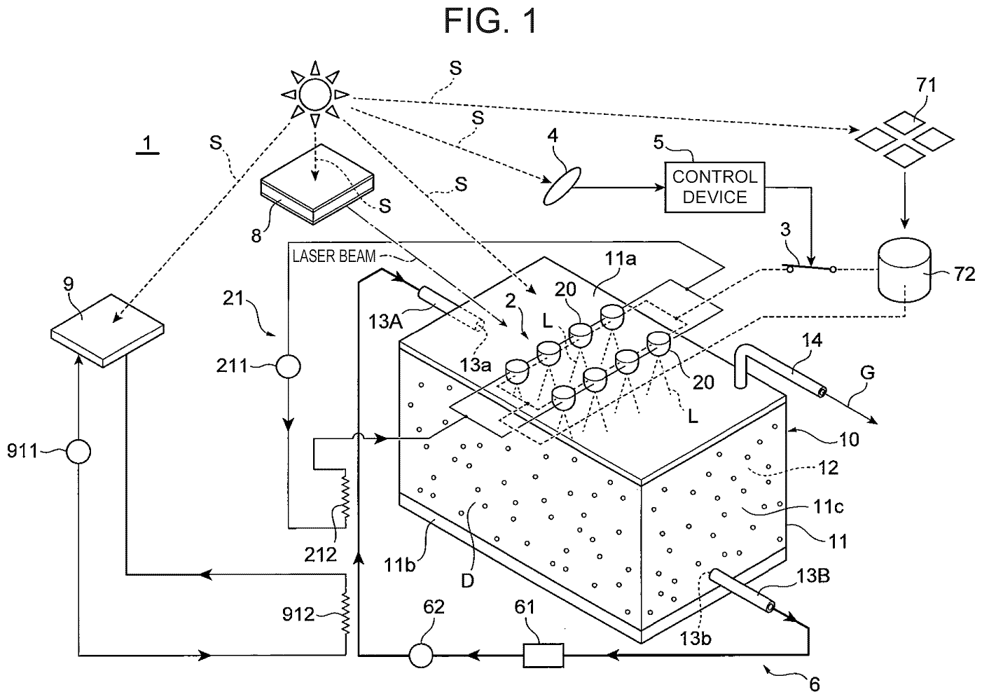

Hereinafter, embodiments of the present disclosure will be described in detail with reference to the drawings of FIG. 1 to FIG. 5. It should be noted that the embodiment described below is an aspect of the present disclosure, and is not intended to limit the technical scope of the present disclosure.

### Configuration

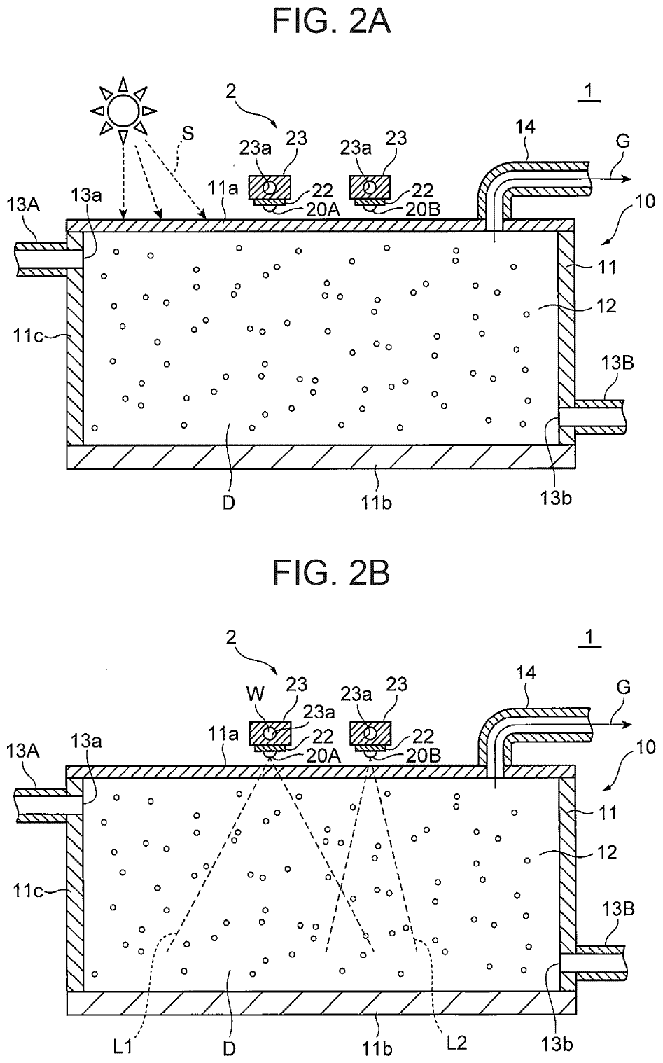

FIG. 1 is an overall schematic diagram of a gas generation system 1 according to the present embodiment. FIGS. 2A and 2B are cross-sectional views of the housing 11 and the irradiation device 2 shown in FIG. 1. The gas generation system 1 is a system for causing the photocatalyst to contribute to the decomposition reaction of water, and thereby generating a mixed gas G composed of oxygen gas and hydrogen gas. The water in contact with the photocatalyst is decomposed by the sunlight S in an environment such as a sunny day, and the mixed gas G is generated. Here, in the present embodiment, the water in contact with the photocatalyst is water of the dispersion liquid D in which the particles of the photocatalyst are dispersed.

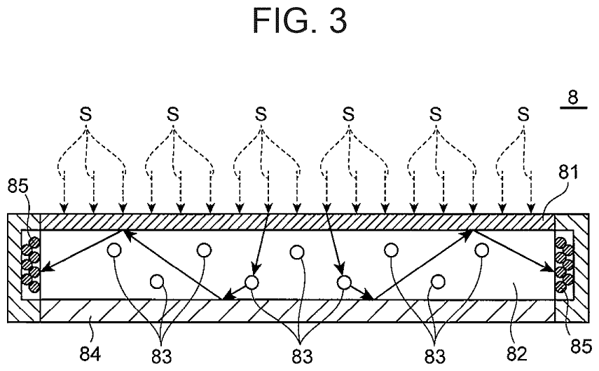

The gas generation system 1 includes a gas generation device 10 having a housing 11 and an irradiation device 2. The gas generation system 1 further includes an irradiation device 2, a switch 3, a pyranometer 4, a control device 5, and the like. The gas generation system 1 further includes a solar battery 71 and a storage battery 72. The gas generation device 10 includes a housing 11, and an accommodation space 12 for storing the dispersion liquid D is formed inside the housing 11. The housing 11 includes a light-transmission wall 11a as a top plate, a reflector 11b as a bottom plate, and a sidewall 11c. The sidewall 11c rises from the periphery of the reflector 11b. The light-transmission wall 11a covers an upper opening of the sidewall 11c. Thus, the housing 11 is formed with the accommodation space 12 surrounded by the light-transmission wall 11a, the reflector 11b, and the sidewall 11c. The light-transmission wall 11a transmits the sunlight S that has directly or indirectly reached toward the accommodation space 12. In the present embodiment, the light-transmission wall 11a is only a top plate, but for example, the sidewall 11c may also function as a light-transmission wall through which the sunlight S is transmitted. Here, the “directly reached sunlight S” is light directly emitted by sunlight S. On the other hand, the term “indirectly reached sunlight” refers to the sunlight S that is converted into laser light having a particular wavelength by the laser device 8 described below with reference to FIG. 3 and causes the laser light to reach the light-transmission wall 11a. The reflector 11b reflects the sunlight S transmitted through the light-transmission wall 11a. Accordingly, the sunlight S is suppressed from leaking to the outside of the accommodation space 12, and the sunlight S is easily irradiated onto the photocatalyst in the dispersion liquid D.

A gas discharge pipe 14 for discharging the mixed gas G generated in the accommodation space 12 is connected to the housing 11. The gas discharge pipe 14 is connected to the housing 11 so as to pass through the light-transmission wall 11a. As a result, the gas flow path of the gas discharge pipe 14 can be communicated with the accommodation space 12, so that the mixed gas G generated in the accommodation space 12 can be discharged from the accommodation space 12 to the outside of the accommodation space 12 via the gas discharge pipe 14. The leading end of the gas discharge pipe 14 on the side from which the mixed gas G is discharged may be connected to a separator (not shown) capable of separating at least one of the oxygen gas and the hydrogen gas from the mixed gas G.

The gas generation system 1 further includes a circulation system 6 that circulates the dispersion liquid D accommodated in the accommodation space 12. In the present embodiment, the circulation system 6 supplies the dispersion liquid D discharged from the discharge port 13b again from the supply port 13a to the accommodation space 12 via the tank 61 and the liquid feed pump 62. Accordingly, since the dispersion liquid D in the accommodation space 12 can be circulated, it is possible to suppress the photocatalyst of the dispersion liquid D from staying in the accommodation space 12. In particular, the supply pipe 13A having the supply port 13a is connected to a higher position of the housing 11 as compared to the discharge pipe 13B having the discharge port 13b. As a result, the photocatalyst precipitated at the bottom of the accommodation space 12 can be efficiently circulated to the circulation system 6. If the dispersion liquid D does not contain a photocatalyst and a sheet of the photocatalyst is held in the accommodation space 12, only water may be circulated instead of the dispersion liquid D.

The storage battery 72 stores electric energy generated by the solar battery 71, and the irradiation device 2 is supplied with the electric energy stored in the storage battery 72 via the switch 3. In the present embodiment, electric energy is supplied from the storage battery 72 to the irradiation device 2, but for example, a commercial power source or the like may be used instead of the storage battery 72.

As shown in FIG. 1, the irradiation device 2 includes a plurality of (for example, eight) light-emission elements 20 that are irradiation sources of the artificial light L. The plurality of light-emission elements 20 are composed of a plurality of electrically connected element groups, and the respective element groups are connected in parallel (see broken lines in FIG. 1). Light-emission elements 20 (20A, 20B: see FIG. 2A) constituting the respective groups of elements are connected in series, and emit artificial light L (L1, L2: see FIG. 2B) of different wavelengths. Since the gas generation system 1 includes the irradiation device 2, the irradiation device 2 can irradiate the photocatalyst in the accommodation space 12 with the artificial light L even in an environment where a sufficient energy amount of the sunlight S cannot be obtained, such as at night or in a bad weather.

As shown in FIGS. 2A and 2B, the respective element groups of the light-emission element 20 are supported by the support 23 via the wiring circuit board 22. The support 23 is installed above the light-transmission wall 11a so that the artificial light L emitted from the light-emission element 20 is irradiated toward the light-transmission wall 11a. A water pipe 23a is formed in the support 23 so as to penetrate the central portion along the longitudinal direction thereof. The coolant W of the cooling system 21, which will be described later, passes through the water pipe 23a. Note that, without using the cooling system 21, the heat generated from the light-emission element 20 may be conducted to the housing 11 by a thermally conductive material made of metal or the like, and the dispersion liquid D may be heated via the housing 11.

The gas generation system 1 includes a cooling system 21 that cools the light-emission element 20 with the coolant W. The cooling system 21 is a system that allows the coolant pumped by the pump 211 to pass through the irradiation device 2. The heat absorbed from the light-emission element 20 to the coolant W is introduced into the dispersion liquid D of the circulation system 6 via the heat exchanger 212. In this way, the dispersion liquid D can be heated by the exhaust heat of the light-emission element 20 via the coolant W of the cooling system 21. The photocatalyst of the dispersion liquid D is heated, and the activity of the photocatalyst in the accommodation space 12 can be enhanced.

The gas generation system 1 may also comprise a solar collector 9. The solar collector 9 is a device for converting sunlight S into thermal energy, and the converted thermal energy can be pumped and circulated by the pump 911. Then, the heat exchanger 912 can perform heat exchange between the converted heat energy and the dispersion liquid D after being pumped from the liquid feed pump 62 of the circulation system 6. As a result, as in the case of the cooling system 21, the dispersion liquid D can be heated by the heat collected in the heat exchanger 912. The photocatalyst of the dispersion liquid D is heated, and the activity of the photocatalyst in the accommodation space 12 can be enhanced. In the embodiment shown in FIG. 1, the dispersion liquid D that has been pumped from the liquid feed pump 62 is heated by the solar collector 9. However, for example, by arranging the solar collector 9 in a V-shape below the housing 11, the dispersion liquid D in the accommodation space 12 may be heated by the solar collector 9 from the outside of the housing 11.

FIG. 3 is a schematic diagram for explaining the principle of the laser device 8 shown in FIG. 1. The laser device 8 includes a dichroic mirror 81, a resin base material 82, a high reflection mirror 84, an optical fiber 85, and the like. A fluorescent agent 83 is dispersed in the resin base material 82. A dichroic mirror 81 is disposed on an upper surface of the resin base material 82, and a high reflection mirror 84 is disposed on a lower surface thereof. An optical fiber 85 is wound around the peripheral surface of the resin base material 82. When the laser light is generated, the sunlight S transmitted through the dichroic mirror 81 is absorbed by an arbitrary fluorescent agent 83, and the fluorescent agent 83 emits light. The emitted light is reflected by the dichroic mirror 81 and the high reflection mirror 84, and is condensed on the optical fiber 85. The condensed light passes through a cladding (not shown) in the optical fiber 85 to reach a core (not shown), and the laser medium is excited to generate laser light. The laser beam reaches the light-transmission wall 11a as indirect sunlight.

The dichroic mirror 81 may be a dielectric multilayer film prepared from SiO₂, TiO₂ or the like. The resin base material 82 may be made of a resin such as quartz glass, polycarbonate resin, PMMA, acryl resin, silicone resin, fluorine-based resin, or urethane resin. Further, the fluorescent agent 83 may be made of any material that absorbs the sunlight S and emits fluorescence, such as a fluorescent dye (rhodamine, Lumogen, or the like) or a quantum dot (PbI3, PbS, CdTe, Si or the like). The high reflection mirror 84 may be formed of an Al film or the like. The laser medium dispersed in the core of the optical fiber 85 may be a material such as neodymium ions or ytterbium ions, and the core may be made of glass (typically quartz glass) doped with these ions. The cladding on the outside of the core may be formed of a glass material having a lower refractive index than the core.

In the present embodiment, the gas generation system 1 is used in the manner shown in FIGS. 2A and 2B by switching the switch 3 using the control device 5. Specifically, in the embodiment shown in FIG. 2A, the photocatalyst in the dispersion liquid D is activated by the sunlight S by opening the switch 3 in a sunny day or the like. On the other hand, in the embodiment shown in FIG. 2B, by closing the switch 3, the photocatalyst in the dispersion liquid D is activated by the artificial light L (L1, L2) which emits light from the plurality of light-emission elements 20 (20A, 20B) of the irradiation device 2 in an environment such as at night or in bad weather.

The switch 3 selectively switches supply or supply of power to the irradiation device 2 by opening and closing an electric circuit between the storage battery 72 and the irradiation device 2. Specifically, the control device 5 controls the opening and closing operation of the switch 3 through the following steps. First, the energy amount of the sunlight S is measured using the pyranometer 4 installed in an environment irradiated with the sunlight S. Next, the control device 5 compares the energy amount of the sunlight S measured by the pyranometer 4 with a preset threshold value. When the energy amount of the sunlight S becomes less than or equal to the threshold value, the control device 5 controls the switch 3 so as to switch the supply of electric power to the irradiation device 2, assuming that the energy amount is not sufficient. That is, the switch 3 controls the electric circuit to be in the closed state. Thus, even in conditions such as at night or bad weather, it is possible to efficiently irradiate the artificial light L from the irradiation device 2 to the photocatalyst, it can be easily switched to the irradiation by the artificial light L by the control device 5. When the energy amount of the sunlight S exceeds the threshold value, the control device 5 switches the switch 3 so as to stop the supply of electric power to the irradiation device 2. Here, the switch 3 may be a relay (not shown), an element, or the like as long as it has the above-described functions. Further, as the switching means of the switch 3 by the control device 5, a means for switching based on the time may be applied in addition to the means for switching based on the energy amount of the sunlight S.

As described above, by selectively switching the modes shown in FIGS. 2A and 2B by opening and closing the switch 3, it is possible to continuously decompose water in any of the environments. In FIG. 2A, the control device 5 controls the switch 3 to be in the open state when the energy amount of the sunlight S measured by the pyranometer 4 is larger than a predetermined threshold. However, the electric circuit may be manually closed, and the irradiation of the sunlight S and the irradiation of the artificial light L may be used in combination.

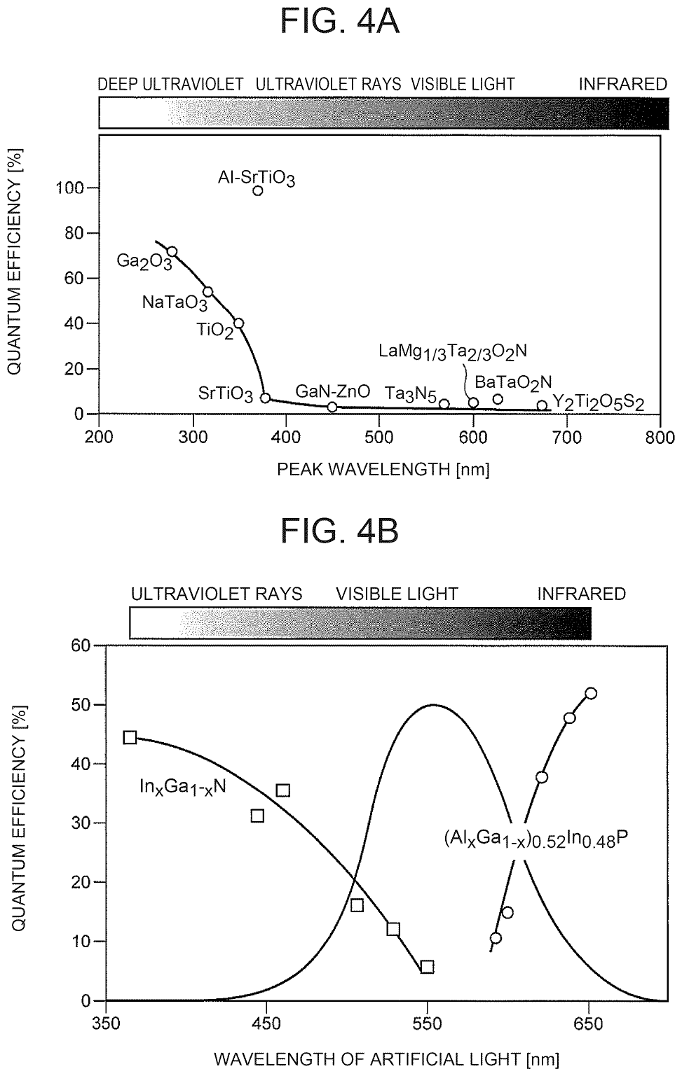

Here, referring to FIG. 4A, the relation between the peak wavelength of the photocatalyst and the quantum-efficiency will be described. As shown in FIG. 4A, the peak wavelength at which the photocatalyst absorbs light varies depending on the photocatalyst. In addition, the quantum efficiency is different for each photocatalyst, and the quantum efficiency is high when the peak wavelength is short. The quantum efficiency is proportional to the production efficiency of the mixed gas. Therefore, the photocatalyst that absorbs light at a low wavelength such as ultraviolet rays has a higher generation efficiency of the mixed gas than other photocatalysts.

Therefore, in the present embodiment, the peak wavelength is roughly divided into the following three types of wavelength regions. Specifically, it is roughly classified into a wavelength region of ultraviolet rays including deep ultraviolet rays (a wavelength region from 10 nm to 380 nm, and hereinafter also referred to as a “low wavelength region”), a wavelength region of visible light (a wavelength region from 430 nm to 550 nm, and hereinafter also referred to as a “medium wavelength region”), and a wavelength region of infrared rays (a wavelength region from 570 nm to 770 nm, and hereinafter also referred to as a “high wavelength region”).

Examples of the material of the photocatalyst containing the peak wavelength in the low wavelength region include, La₂Ti₂O₇, BaTiO₃, Na₂TiO₃, ZrO₂, Rb₄Nb₆O₁₇, K₂Rb₂Nb₆O₁₇, Pb₁₋ₓK₂ₓNbO₆ (0<x<1), in addition to Ga₂O₃, NaTaO₃, TiO₂, SrTiO₃, Al—SrTiO₃. In addition to GaN—ZnO, examples of the photocatalyst in which the peak wavelength is included in the medium wavelength region include Rh—SrTiO₃. Examples of the photocatalyst material containing the peak wavelength in the high wavelength region include, α-Fe₂O₃, K₄Nb₆O₁₇, in addition to Ta₃N₅, LaMg_{1/3}Ta_{2/3}O₂N, BaTaO₂N, Y₂Ti₂O₅S₂.

Here, the type of the photocatalyst contained in the dispersion liquid D is not limited as long as it absorbs light by the sunlight S and the artificial light L. For example, the photocatalyst may be composed of only a material in a high-wavelength region shown in FIG. 4A. However, in the present embodiment, the photocatalyst includes the first photocatalyst and the second photocatalyst. Therefore, particles of the first photocatalyst and particles of the second photocatalyst are dispersed in the dispersion liquid D.

In the present embodiment, the first photocatalyst is a catalyst that absorbs light at a peak wavelength within a wavelength region (long wavelength region) of infrared rays. The second photocatalyst is a catalyst that absorbs light in a low wavelength region (specifically, a wavelength region of ultraviolet rays) lower than the peak wavelength of infrared rays.

In the present embodiment, the light-emission element 20 includes a first light emission element 20A and a second light emission element 20B in which each of the first and second photocatalysts easily absorbs light. The first light emission element 20A and the second light emission element 20B emit, as the artificial light L, the first artificial light L1 and the second artificial light L2, respectively. The first light emission element 20A emits light in a long wavelength region including a peak wavelength of the first photocatalyst. The second light emission element 20B emits light in a low wavelength region including the low peak wavelength of the second photocatalyst.

FIG. 4B is a graph showing the relation between the wavelength and the quantum efficiency of the artificial light L for the material of the light-emission element 20. In the present embodiment, the first light emission element 20A emits the first artificial light L1 in the infrared-wavelength region. On the other hand, the second light emission element 20B emits the second artificial light L2 in the wavelength region of ultraviolet rays. Examples of the first light emission element 20A include (AlₓGa₁₋ₓ)_{0.52}In_{0.48}P. Examples of the second light emission element 20B include InₓGa₁₋ₓN, diamond, and GaN, AlGaN.

As shown in FIG. 4A, when the first photocatalyst in the dispersion liquid D has a peak wavelength in the wavelength region of infrared rays, the quantum efficiency is lower than that of the second photocatalyst having a peak wavelength in the wavelength region of ultraviolet rays. Therefore, when the first artificial light L1 and the second artificial light L2 is irradiated with the same amount of the first photocatalyst and the second photocatalyst, the amount of the mixed gas generated by the first photocatalyst is less than that of the second photocatalyst. Therefore, it is preferable that the amount of light of the first artificial light L1 of the first light emission element 20A is larger than the amount of light of the second artificial light L2 of the second light emission element 20B. Specifically, the control device 5 may perform the energization control so that the current supplied to the first light emission element 20A is larger than that of the second light emission element 20B. Accordingly, the amount of light of the first artificial light L1 can be increased without increasing the number of the first light emission elements 20A.

In the present embodiment, the first photocatalyst and the second photocatalyst having different peak wavelengths of light absorption are accommodated in the accommodation space 12 in a mixed state. As shown in FIG. 2A, when the sunlight S is irradiated, the first photocatalyst that absorbs light at the peak wavelength is activated, and a water-decomposition reaction can occur. On the other hand, when the irradiation of the sunlight S is insufficient, the first photocatalyst is activated by the first artificial light L1 irradiated from the first light emission element 20A of the irradiation device 2, as shown in FIG. 2B. Further, the second photocatalyst is activated by the second artificial light L2 irradiated from the second light emission element 20B. In each photocatalyst, a decomposition reaction of water can occur.

As the photocatalyst, in addition to the first photocatalyst and the second photocatalyst, a third catalyst that absorbs light at a peak wavelength of a medium wavelength may be used. In this case, the irradiation device 2 may include a third element that irradiates the third artificial light absorbed by the third catalyst.

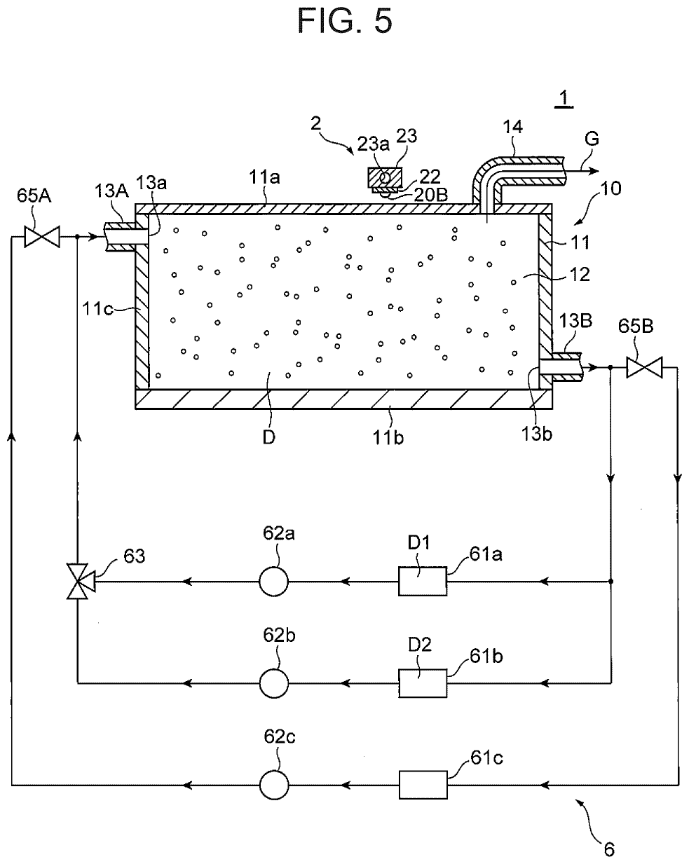

FIG. 5 is a schematic diagram illustrating another example of the configuration of the circulation system 6 in the gas generation system 1 according to the present embodiment. Note that the gas generation device 10 and the irradiation device 2 are the same as those shown in FIGS. 2A and 2B, and thus detailed explanation thereof is omitted. In FIG. 5, the dispersion liquid D comprises a first dispersion liquid D1 comprising particles of a first photocatalyst and a second dispersion liquid D2 comprising a second photocatalyst. The circulation system 6 has a first tank 61a and a first liquid feed pump 62a, and a second tank 61b and a second liquid feed pump 62b on the flow path of each of the dispersion liquids D. The first dispersion liquid D1 is contained in a first tank 61a and the second dispersion liquid D2 is contained in a second tank 61b.

Further, the circulation system 6 has a three-way valve 63 that switches between the supply of the first dispersion liquid D1 from the first tank 61a to the accommodation space 12 and the supply of the second dispersion liquid D2 from the second tank 61b to the accommodation space 12. As a result, the particles of the first photocatalyst and the particles of the second photocatalyst having different peak wavelengths of light absorption can be selectively supplied to the accommodation space 12. Specifically, when the sunlight S is irradiated, the control device 5 switches the three-way valve 63, supplies the first dispersion liquid D1 to the accommodation space 12, and causes the first photocatalyst to decompose water. On the other hand, when the sunlight S is not sufficiently irradiated, the control device 5 switches the three-way valve 63, supplies the second dispersion liquid D2 to the accommodation space 12, and causes the second photocatalyst to decompose water. Here, the three-way valve 63 corresponds to a switching valve in the present disclosure. However, other configurations may be used as long as the supply of the particles of the first photocatalyst and the particles of the second photocatalyst to the accommodation space 12 can be switched. For example, an on-off valve may be provided downstream of each of the first liquid feed pump 62a and the second liquid feed pump 62b, and the on-off valves may be individually opened and closed.

Further, the circulation system 6 may have a third tank 61c for circulating only water, a third liquid feed pump 62c, and an on-off valve 65A, 65B for switching between supplying and stopping the water. Thus, prior to the switching between the supply of the first dispersion liquid D1 and the supply of the second dispersion liquid D2 by the three-way valve 63, the opening/closing valve 65A, 65B is opened to circulate only water, and the one dispersion liquid D remaining in the accommodation space 12 before the switching can be removed by the water flow. Therefore, even if the other dispersion liquid D is supplied to the accommodation space 12, it is possible to suppress both dispersion liquids D to be mixed. Alternatively, one of the dispersion liquids D collected in the third tank 61c may be returned to the first tank 61a or the second tank 61b.

In addition, the irradiation device 2 may include at least the second light emission element 20B. The second photocatalyst in the second dispersion liquid D2 is caused to contribute to the water-decomposition reaction by selectively circulating the second dispersion liquid D2 and irradiating the second artificial light L2 from the second light emission element 20B. As a result, a larger amount of the mixed gas G can be generated as compared with the case where the first photocatalyst contributes to the decomposition reaction of water. In addition, the first photocatalyst in the first dispersion liquid D1 can contribute to the water-decomposition reaction by irradiating the sunlight S in an environment such as a sunny day. Therefore, the first dispersion liquid D1 may be selectively circulated.

What is claimed is:

1. A gas generation system that decomposes water in contact with a photocatalyst by sunlight and generates a mixed gas made of oxygen gas and hydrogen gas, the gas generation system comprising:
a housing in which an accommodation space that accommodates the water and the photocatalyst is formed, the housing having a light-transmission wall that transmits the sunlight directly or indirectly reaching a wall portion of at least one portion that forms the accommodation space;
an irradiation device that emits artificial light having a peak wavelength to be absorbed by the photocatalyst and irradiates the artificial light that is emitted to the light-transmission wall by a supply of power; and
a switch that selectively switches a supply or a supply stop of power to the irradiation device.

2. The gas generation system according to claim 1, further comprising:
a pyranometer that measures an energy amount of the sunlight; and
a control device that controls the switch to switch to a supply of power to the irradiation device when the energy amount becomes equal to or less than a preset threshold.

3. The gas generation system according to claim 1, wherein:
a dispersion liquid in which particles of the photocatalyst are dispersed in the water is accommodated in the accommodation space;
the gas generation system further includes a circulation system that circulates the dispersion liquid accommodated in the accommodation space; and
the circulation system includes a tank that recovers the dispersion liquid from the accommodation space and a pump that feeds the dispersion liquid collected in the tank to the accommodation space.

4. The gas generation system according to claim 1, wherein:
the photocatalyst includes a first photocatalyst that absorbs light at the peak wavelength and a second photocatalyst that absorbs light at a low peak wavelength lower than the peak wavelength; and
the irradiation device includes a first light emission element that emits light within a wavelength region that includes the peak wavelength and a second light emission element that emits light within a low wavelength region that includes the low peak wavelength.

5. The gas generation system according to claim 3, wherein:
the photocatalyst includes a first photocatalyst that absorbs light at the peak wavelength and a second photocatalyst that absorbs light at a low peak wavelength lower than the peak wavelength;
the dispersion liquid includes a first dispersion liquid that contains particles of the first photocatalyst and a second dispersion liquid that contains the second photocatalyst;
the tank includes a first tank in which the first dispersion liquid is accommodated and a second tank in which the second dispersion liquid is accommodated;
the circulation system further includes a switching valve that switches between a supply of the first dispersion liquid from the first tank to the accommodation space and a supply of the second dispersion liquid from the second tank to the accommodation space; and
the irradiation device includes at least a light-emission element that emits light within a wavelength region that includes the low peak wavelength.
